(19) United States
(12) Patent Application Publication
(10) Pub. No.: US 2010/0072081 A1
(43) Pub. Date: Mar. 25, 2010

(54) GAS TREATING APPARATUS AND METHOD

(75) Inventors: Han Young YU, Daejeon (KR); Byunghoon Kim, Incheon (KR); Soonyoung Oh, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/394,554

(22) Filed: Feb. 27, 2009

(30) Foreign Application Priority Data
Sep. 19, 2008 (KR) 10-2008-0092108

(51) Int. Cl. F17C 11/00; F17C 1/00

(52) U.S. Cl. 206/7; 220/581

(57) ABSTRACT

Provided is a gas treating apparatus. The gas treating apparatus includes a storage chamber having a top wall, a bottom wall facing the top wall, and a sidewall connecting the top wall to the bottom wall, a gas collecting unit provided in the storage chamber and storing ionized gas, and an electromagnetic field generator converting a moving direction of the ionized gas. The electromagnetic generator includes at least one of a magnetic field generator generating a magnetic field in the storage chamber and an electric field generator generating an electric field in the storage chamber.

### CROSS-REFERENCE TO RELATED APPLICATIONS

This U.S. non-provisional patent application claims priority under 35 U.S.C. §119 of Korean Patent Application No. 10-2008-0092108, filed on Sep. 19, 2008, the entire contents of which are hereby incorporated by reference.

### BACKGROUND OF THE INVENTION

The present invention disclosed herein relates to a gas treating apparatus, and more particularly, to an apparatus and method for storing hydrogen gas.

Generally, hydrogen is rich in the natural world and is drawing attention as the upcoming alternative energy source as it does not generate pollutants during combustion. In order to effectively use the hydrogen, it is important to improve the storage and supplying efficiency of the hydrogen. A compressed hydrogen gas storage method, a liquid hydrogen storage method, and a hydrogen storage method using a hydrogen gas collecting device have been widely used as the hydrogen storage method. Among these methods, the hydrogen storage method using the hydrogen gas collecting device has been widely used, as it is relatively safe. However, this method has relatively low hydrogen storage and supplying efficiency.

### SUMMARY OF THE INVENTION

The present invention provides a gas treating apparatus that can improve gas storage efficiency.

The present invention also provides a gas treating apparatus that can improve gas supplying efficiency.

The present invention also provides a gas treating method that can improve gas storage efficiency.

The present invention also provides a gas treating method that can improve gas supplying efficiency.

Embodiments of the present invention provide gas treating apparatuses including a storage chamber having a top wall, a bottom wall facing the top wall, and a sidewall connecting the top wall to the bottom wall, a gas collecting unit provided in the storage chamber and storing ionized gas, and an electromagnetic field generator converting a moving direction of the ionized gas. The electromagnetic generator includes at least one of a magnetic field generator generating a magnetic field in the storage chamber and an electric field generator generating an electric field in the storage chamber.

In some embodiments, the magnetic field generator may include a plate-shaped magnet on the sidewall and the electric field generator may include electrodes on the top and bottom walls.

In other embodiments, the magnetic field generator may include a coil enclosing the top wall, bottom wall, and sidewall and the electric field generator may include electrodes on the top and bottom walls.

In still other embodiments, the magnetic field generator may include plate-shaped magnets on the top and bottom walls and the electric field generator may include electrodes on the sidewall.

In even other embodiments, the magnetic field generator may include a coil enclosing the sidewall, and the electric field generator may include electrodes on the sidewall.

In other embodiments of the present invention, gas treating methods using a storage chamber and a gas collecting unit dispose in the storage chamber include storing ionized gas in the gas collecting unit by generating at least one of magnetic field and electric field.

In some embodiments, the electric field may be provided in an inflow direction of the ionized gas introduced into the storage chamber, and the magnetic field may be provided in a direction intersecting the inflow direction.

In other embodiments, the electric field may be provided in a direction intersecting an inflow direction of the ionized gas introduced into the storage chamber, and the magnetic field may be provided in the inflow direction.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a schematic view of a gas treating apparatus according to an exemplary embodiment of the present invention;

FIG. 2 is a schematic view illustrating a magnetic field and an electric field in a gas storage unit of FIG. 1.

FIG. 3 is a flowchart illustrating a gas treating method according to an exemplary embodiment of the present invention;

FIG. 4 illustrates a gas flow during a gas treating process of the gas treating apparatus of FIGS. 1 and 2;

FIG. 5 is a schematic view of a modified example of the gas treating apparatus of the exemplary embodiment of the present invention;

FIG. 6 is a schematic view of magnetic field and electric field in a gas storage unit of FIG. 5;

FIG. 7 is a schematic view of a gas treating apparatus according to another exemplary embodiment of the present invention;

FIG. 8 is a schematic view illustrating a magnetic field and an electric field in a gas storage unit of FIG. 7;

FIG. 9 illustrates a gas flow during a gas treating process of the gas treating apparatus of FIGS. 7 and 8;

FIG. 10 is a schematic view of a modified example of the gas treating apparatus of the exemplary embodiment of FIGS. 7 and 8; and

FIG. 11 is a schematic view of magnetic and electric fields in a gas storage unit of FIG. 10.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the figures, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

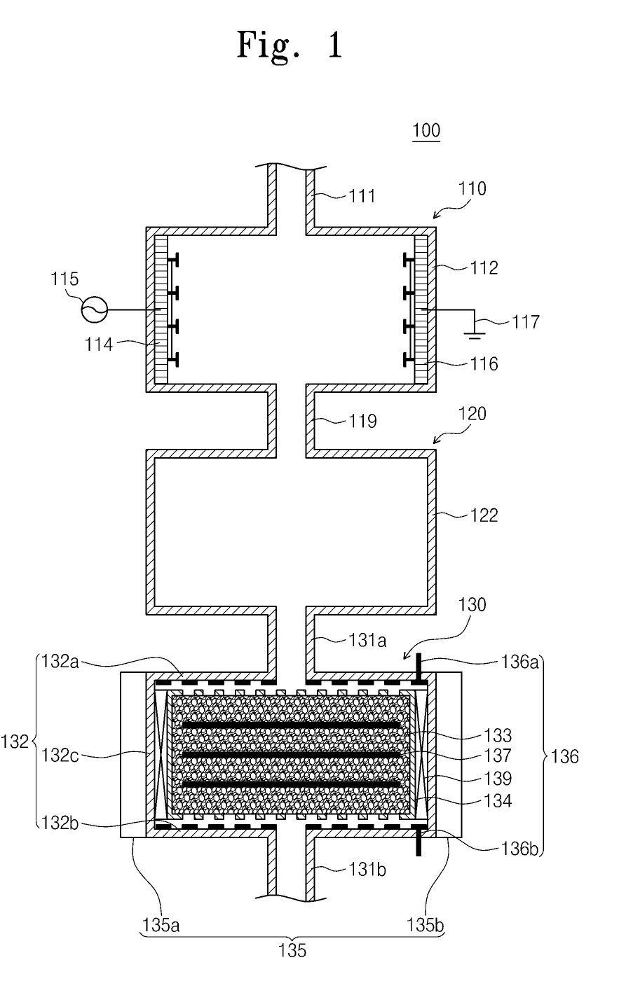

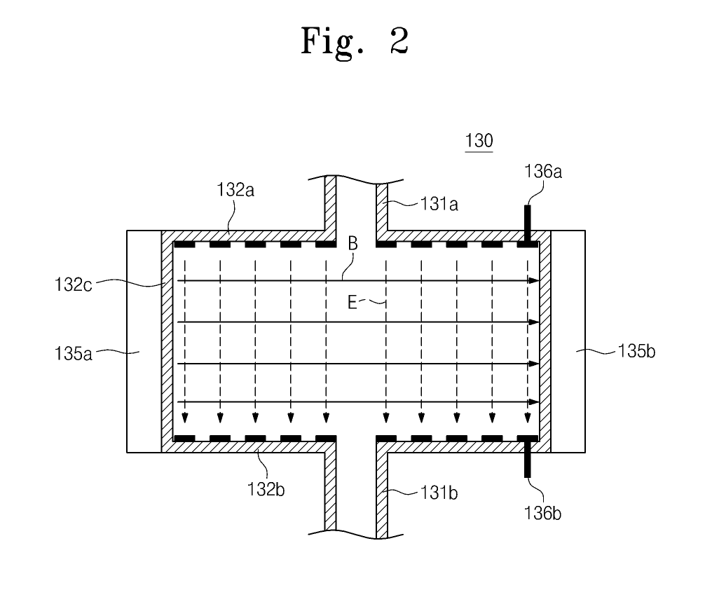

FIG. 1 is a schematic view of a gas treating apparatus according to an exemplary embodiment of the present invention, and FIG. 2 is a schematic view illustrating a magnetic field and an electric field in a gas storage unit of FIG. 1.

Referring to FIGS. 1 and 2, a gas treating apparatus 100 according to an exemplary embodiment of the present invention may include a gas ionizing unit 110, a gas pressurizing unit 120, and a gas storage unit 130.

The gas ionizing unit 110 can ionize gas. For example, the gas may include hydrogen (H₂) gas, and the gas ionizing unit 110 can ionize the hydrogen gas. The gas ionizing unit 110 may include an ionizing chamber 112 and first and second ionizing electrodes 114 and 116. The ionizing chamber 112 may have an inner space in which the gas is ionized. The ionizing chamber 112 may include a gas inlet port 111 and a gas outlet port 119. The first ionizing electrode 114 is disposed on one sidewall of the ionizing chamber 112 and the second ionizing electrode 116 may be disposed on opposite sidewall of the ionizing chamber 112. The first and second ionizing electrodes 114 and 116 may be disposed facing each other in the ionizing chamber 112. An insulation material may be disposed between the first and second ionizing electrodes 114 and 116 and the ionizing chamber 112. The first ionizing electrode 114 may receive electric power from an electric power applier 115. The second ionizing electrode 116 may be grounded by being connected to an earth line 117.

The gas pressurizing unit 120 can pressurize the ionized gas. For example, the gas pressurizing unit 120 may include a pressurizing chamber 122. The pressurizing chamber 122 is connected to the gas outlet port 119 to receive the ionized gas. The pressurizing chamber 122 pressurizes the ionized gas to supply the pressurized ionized gas to the gas storage unit 130. The pressurizing chamber 122 may include at least one compressor.

The gas storage unit 130 can store the ionized gas. The gas storage unit 130 may include a storage chamber 132, a gas collecting unit 133, and an electromagnetic field generator.

The storage chamber 132 may have an inner space in which the ionized gas can be stored. For example, the storage chamber 132 may be formed in a hexahedron shape. Alternatively, the storage chamber 132 may be formed in a cylindrical shape. The storage chamber 132 may include a top wall 132a, a bottom wall 132b, and a sidewall 132c connecting the top wall 132a to the bottom wall 132b. The top wall 132a may be provided with a gas inlet port 131a. The bottom wall 132b may be provided with a gas supplying port 131b.

The gas collecting unit 133 can store the ionized gas in the storage chamber 132. The gas collecting unit 133 may be disposed in the storage chamber 132. The gas collecting unit 133 may include a material that can collect the ionized gas. For example, the gas collecting unit 133 may include porous microspheres. For example, the gas collecting unit 133 may include nano materials. The gas collecting unit 133 may be formed of a variety of kinds of metal. For example, the gas collecting unit 133 may include carbon, magnesium, steel, titanium, lanthanum, nickel, zirconium, and alloy thereof. The gas collecting unit 133 may be physically fixed in the storage chamber 132 by a gas collecting unit supporting member 134.

The electromagnetic field generator can convert a moving direction of the ionized gas by generating magnetic field and electric field in the storage chamber 132. The electromagnetic field generator may include at least one of a magnetic field generator 135 and an electric field generator 136. In this exemplary embodiment, description is made on a case where both of the magnetic and electric field generators 135 and 136 are provided.

The magnetic field generator 135 can generate the magnetic field B in the storage chamber 132. The magnetic field generator 135 may include at least one magnet. For example, the magnetic field generator 135 may include first and second magnets 135a and 135b. The first and second magnets 135a and 135b may be formed in a plate shape and disposed on the sidewall 132c of the storage chamber 132. For instant, the first magnet 135a is disposed on one side of the sidewall 132c of the storage chamber 132 and the second magnet 135b may be disposed on opposite side of the sidewall 132c. Therefore, the first and second magnets 135a and 135b may be spaced apart from each other and face each other.

The electric field generator 136 can generate electric field E in the storage chamber 132. The electric field E may be alternating current electric field. The electric field generator 136 may include electrodes. For example, the electric field generator 136 may include first and second electrodes 136a and 136b in the storage chamber 132. The first electrode 136a may be disposed on the top wall 132a and the second electrode 136b may be disposed on the bottom wall 132b. The first and second electrodes 136a and 136b may receive predetermined electric power from an electric power applier (not shown).

The gas treating apparatus 100 may further include a reducer and a heating unit 139. The reducer can reduce a moving speed of the ionized gas introduced into the storage chamber 132. For instant, the reducer may include a cooling unit 137 for cooling the gas collecting unit 133. The cooling unit 137 includes at least one of a cooling pin and a cooling plate that is disposed adjacent to the gas collecting unit 133. The cooling pin and plate may be partly or entirely inserted into the gas collecting unit 133. Further, the heating unit 139 may heat the gas collecting unit 133. The heating unit 139 may include at least one heater disposed adjacent to the gas collecting unit 133.

Meanwhile, the magnetic field B and the electric field E may be formed in the storage chamber 132. For example, the first magnet 135a may be disposed such that an N-pole thereof faces the sidewall 132c and the second magnet 135b may be disposed such that an S-pole thereof faces the sidewall 132c. Accordingly, the magnetic field B directing from the first magnet 135a toward the second magnet 135b can be generated in the storage chamber 132. In addition, the first electrode 136a may be positive and the second electrode 136b may be negative. Accordingly, an electric field E directing from the first electrode 136a toward the second electrode 136b can be formed in the storage chamber 132. Therefore, the ionized gas introduced into the storage chamber 132 can rotate on a plane that is perpendicular to the magnetic field B. A rotating radius of the ionized gas in the storage chamber 132 may be adjusted by directions and intensities of the magnetic filed B and electric field E.

The following will describe in detail a gas treating process of the gas treating apparatus 100 according to the exemplary embodiment of the present invention. The contents related to the gas treating apparatus 100, which are already described above, will be omitted or briefed.

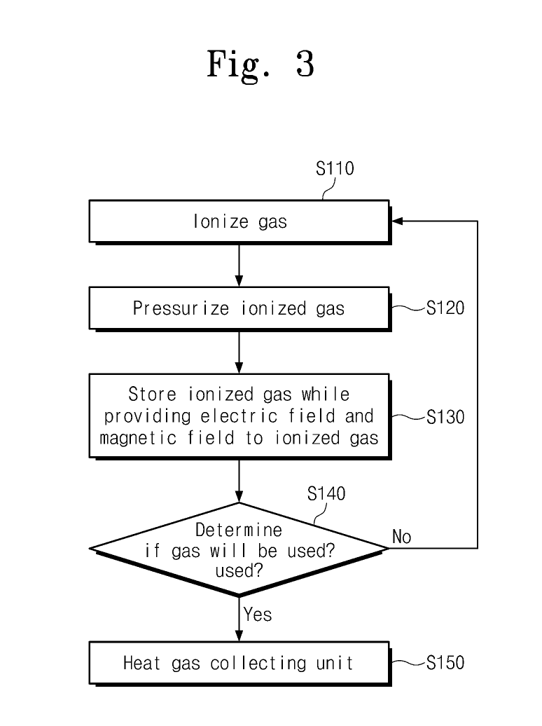

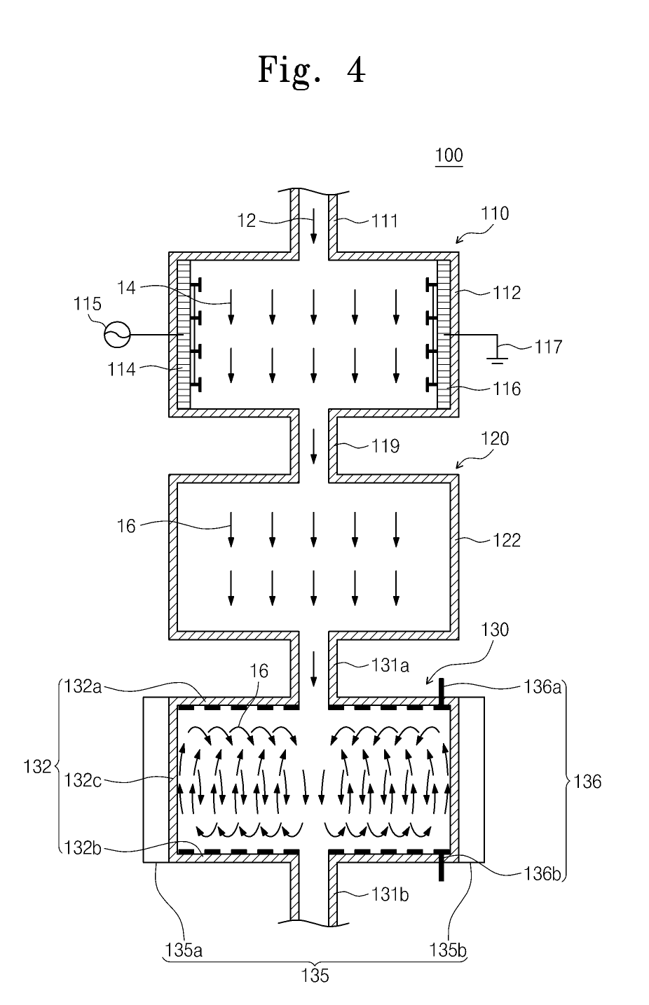

FIG. 3 is a flowchart illustrating a gas treating method according to an exemplary embodiment of the present invention, and FIG. 4 illustrates a gas flow during a gas treating process of the gas treating apparatus of FIGS. 1 and 2.

Referring to FIGS. 1, 3, and 4, gas may be ionized (S110). For example, the gas 12 may be supplied into the ionizing chamber 112 of the gas ionizing unit 110 through the gas inlet port 111. The gas 12 may include the hydrogen gas. The gas 12 supplied to the ionizing chamber 112 may be ionized by being charged by the ionizing electrodes 114 and 116. At this point, ionized gas 14 (hereinafter, referred to as “ion gas”) may include positively charged hydrogen gas (H+). Alternatively, the ionized gas 14 may include negatively charged hydrogen gas (H−). The attraction between the ionized gas 14 and the gas collecting unit 133 increases by ionizing the gas 12 and thus the ion gas storage efficiency of the gas collecting unit 133 can be improved.

The ion gas 14 may be pressurized (S120). For example, the ion gas 14 may be supplied from the ionizing unit 110 to the pressurizing chamber 122 of the gas pressurizing unit 120 through the gas outlet port 119. The pressurizing chamber 122 may supply a pressurized ion gas 16 to the gas storage unit 130 after pressurizing the ion gas 14.

The gas storage unit 130 may store the pressurized ion gas 16 in the storage chamber 132 while providing the magnetic field B and the electric field E to the pressurized ion gas 16 (S130). For example, the pressurized ion gas 16 may be directed into the storage chamber 132 through the gas inlet port 131a. The pressurized ion gas 16 may be guided to stay in the storage chamber 132 by converting its moving direction by the magnetic and electric fields B and E generated in the storage chamber 132. That is, as previously described with reference to FIG. 2, the electric field E may be oriented toward the inflow direction (i.e., downward direction) of the pressurized ion gas 16 into the storage chamber 132. Furthermore, the magnetic field B may be formed in the storage chamber 132 in a direction intersecting the inflow direction of the pressurized ion gas 16. Therefore, the pressurized ion gas 16 can be effectively introduced into the storage chamber 132 by the electric field E and rotates in an upward and downward direction on a plane perpendicular to the magnetic field B. The pressurized ion gas 16 having the upward and downward circulating flow increases in a contact rate with the gas collecting unit 133. Therefore, the gas storage unit 130 can improve a storage rate of the gas collecting unit 133.

Meanwhile, the pressurized ion gas 16 introduced into the storage chamber 132 may decrease in its momentum in or around the storage chamber 132 by the cooling unit 137. For example, the pressurized ion gas 16 introduced into the storage chamber 132 may have a high temperature through the previously described ionizing and pressurizing processes. The pressurized ion gas 16 have a high temperature may move fast and have high reactivity. When the pressurized ion gas 16 moves fast, the pressurized ion gas 16 cannot sufficiently stay in the storage chamber 132 but be discharged out of the storage chamber 132 through the gas outlet port 131b. Further, the pressurized ion gas 16 may not be adsorbed in the gas collecting unit 133 but may move along the periphery of the gas collecting unit 133. Therefore, the cooling unit 137 may substantially reduce the moving speed of the pressurized ion gas 16 by cooling the gas collecting unit 133 and thus cooling the pressurized ion gas 16. In this case, the gas collecting unit 133 may not be heated by the heating unit 139. Through a series of the above-described processes, the gas collecting unit 133 can collect and store the pressurized ion gas 16.

The gas collected in the gas collecting unit 133 may be used according to the following process. For example, it is first determined if the gas will be used (S140). For instant, the gas supplying port 131b may be connected to a process unit (not shown) using the gas stored in the storage chamber 132. When the process unit intends to use the gas stored in the storage chamber 132, the heating unit 139 may heat the gas collecting unit 133 (S150). At this point, the cooling of the gas collecting unit 133 by the cooling unit 137 may be stopped. When the gas collecting unit 133 is heated by the heating unit 139, the hydrogen gas collected in the gas collecting unit 133 is separated from the gas collecting unit 133 and is supplied to the process unit through the gas supplying port 131b. Further, when the use of the gas by the process unit is stopped, the heating of the gas collecting unit 133 by the heating unit 139 may be stopped. In addition, the gas collecting unit 133 is cooled by the cooling unit 237.

As described above, according to this exemplary embodiment of the present invention, the gas that is ionized by the magnetic and electric fields B and E can sufficiently stay in the gas collecting unit 133 and the storage chamber 132 and thus the contact possibility of the ionized gas with the gas collecting unit 133 increases. Therefore, the ionized gas storage efficiency can be improved. In addition, by adjusting the speed of the ion gas introduced into the storage chamber 132 by cooling the gas collecting unit 133, the ion gas storage efficiency can be improved. Furthermore, since the gas stored in the gas collecting unit 133 is used by heating the gas collecting unit 133, the gas supplying efficiency of the gas treating apparatus 100 can be improved.

The following will describe a modified example of the previously described gas treating apparatus according to the exemplary embodiment of the present invention. The contents related to the gas treating apparatus 100, which are already described above, will be omitted or briefed.

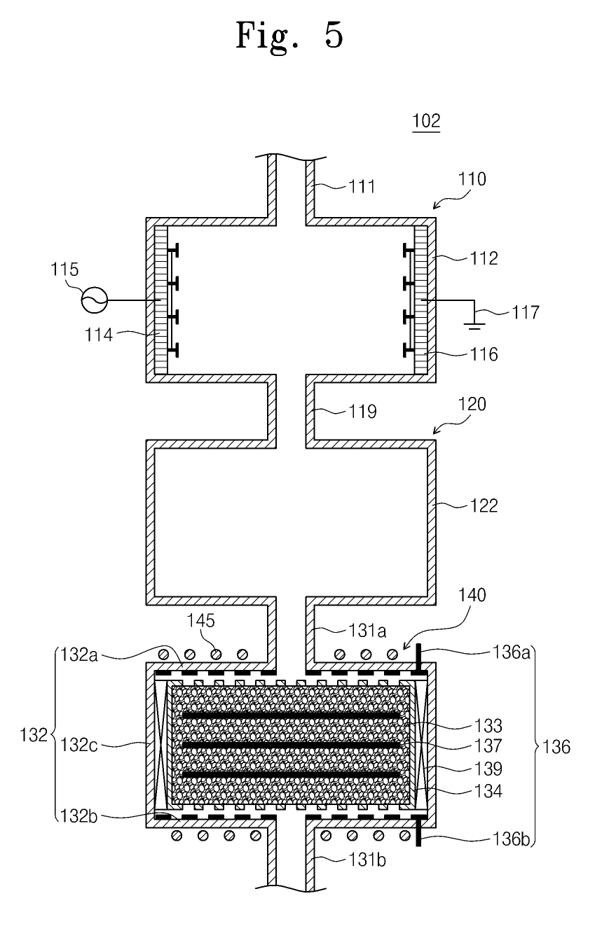

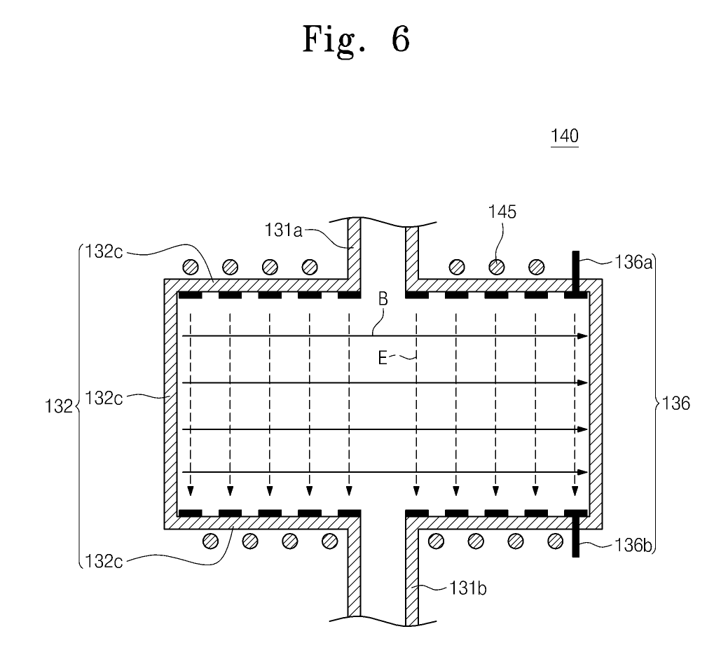

FIG. 5 is a schematic view of a modified example of the gas treating apparatus of the exemplary embodiment of the present invention, and FIG. 6 is a schematic view of magnetic field and electric field in a gas storage unit of FIG. 5.

Referring to FIGS. 5 and 6, a gas treating apparatus 102 according to a modified example of the exemplary embodiment of the present invention includes a gas ionizing unit 110, a gas pressurizing unit 120, and a gas storage unit 140.

The gas ionizing unit 110 may include an ionizing chamber 112 and first and second ionizing electrodes 114 and 116. The ionizing chamber 112 may include a gas inlet port 111 and a gas outlet port 119. The first and second ionizing electrodes 114 and 116 may be disposed facing each other in the ionizing chamber 112. The first electrode 114 may be connected to an electric power applier 115. The second ionizing electrode 116 may be connected to an earth line 117. The gas pressurizing unit 120 may include a pressurizing chamber 122 connected to the gas outlet port 119 and a gas inlet portion 131a. The pressurizing chamber 122 pressurizes the ionized gas to supply the pressurized ionized gas to the gas storage unit 140.

The gas storage unit 140 may include a storage chamber 132, a gas collecting unit 133, and an electromagnetic field generator. The gas treating apparatus 102 may further include a cooling unit 137 cooling the gas collecting unit 133 and a heating unit 139 heating the gas collecting unit 133.

The storage chamber 132 may have an inner space in which the ionized gas can be stored. The storage chamber 132 may be formed in a hexahedron shape. Alternatively, the storage chamber 132 may be formed in a cylindrical shape. The storage chamber 132 may include a top wall 132a, a bottom wall 132b, and a sidewall 132c connecting the top wall 132a to the bottom wall 132b. When the storage chamber 132 is formed in the cylindrical shape, the top wall 132a, bottom wall 132b, and sidewall 132c are rounded to define the cylindrical shape. The top wall 132a may be provided with the gas inlet port 131a. The bottom wall 132b may be provided with a gas supplying port 131b. The gas collecting unit 133 can store the ionized gas. The gas collecting unit 133 may be physically fixed in the storage chamber 132 by a gas collecting unit supporting member 134.

The electromagnetic field generator may include a magnetic field generator 145 and an electric field generator 146. In this case, the magnetic field generator 145 may be formed with coils. In this case, the magnetic field generator 145 may be formed enclosing an outer wall of the storage chamber 132. For example, the magnetic field generator 145 may be disposed enclosing the top wall 132a, bottom wall 132b, and sidewall 132c. The electric field generator 136 can generate electric field E in the storage chamber 132. The electric field E may be alternating current electric field. The electric field generator 136 may include first and second electrodes 136a and 136b in the storage chamber 132. The first electrode 136a may be disposed on the top wall 132a and the second electrode 136b may be disposed on the bottom wall 132b.

Meanwhile, since the magnetic field generator 145 is formed with coils enclosing the storage chamber 132, the magnetic field B may be generated in a horizontal direction by the magnetic field generator 145. Further, the first electrode 136a may be positive and the second electrode 136b may be negative. Accordingly, an electric field E is generated in the storage chamber 132 in a direction (i.e., a vertical direction) intersecting the horizontal direction.

As described above, the gas treating apparatus according to the modified example has the magnetic field generator 145 formed with the coils to generate the magnetic field B in the storage chamber 132. At this point, the directions of the magnetic and electric fields may be similar to the exemplary embodiment of FIG. 2.

The following will describe a gas treating apparatus according to another exemplary embodiment of the present invention. The contents related to the gas treating apparatus 100, which are already described above, will be omitted or briefed.

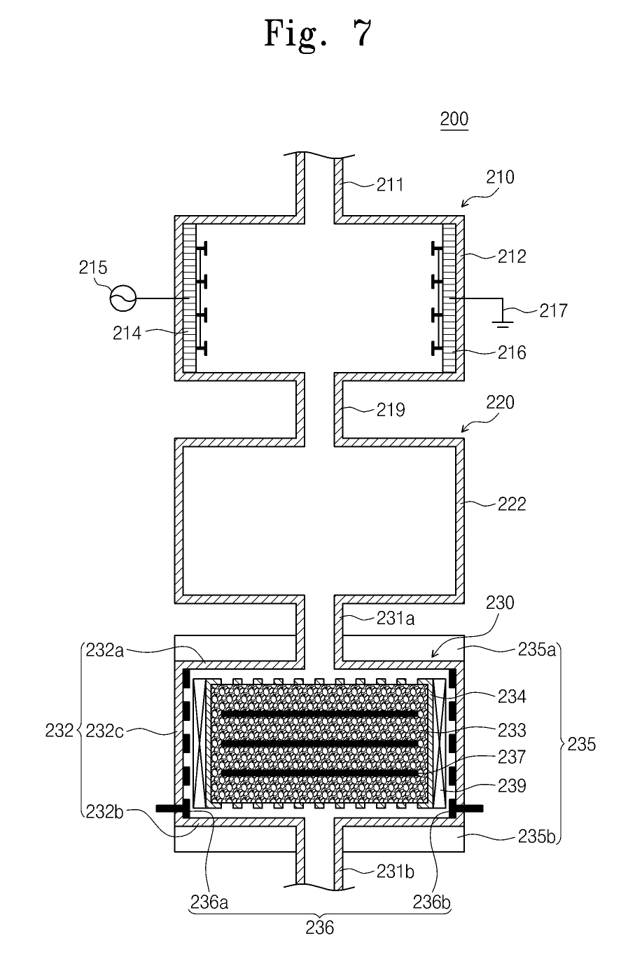

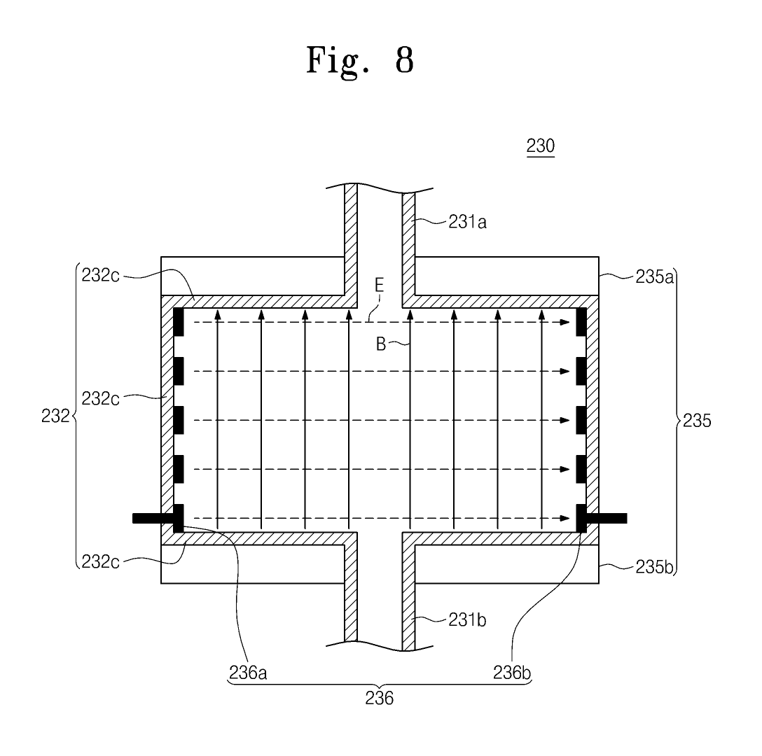

FIG. 7 is a schematic view of a gas treating apparatus according to another exemplary embodiment of the present invention, and FIG. 8 is a schematic view illustrating a magnetic field and an electric field in a gas storage unit of FIG. 7.

Referring to FIGS. 7 and 8, a gas treating apparatus 200 according to another exemplary embodiment of the present invention may include a gas ionizing unit 210, a gas pressurizing unit 220, and a gas storage unit 230.

The gas ionizing unit 210 can ionize gas. For example, the gas may include hydrogen (H₂) gas, and the gas ionizing unit 210 can ionize the hydrogen gas. The gas ionizing unit 210 may include an ionizing chamber 212 having a space in which the hydrogen gas is ionized and first and second ionizing electrodes 214 and 216 disposed in the ionizing chamber 212. The ionizing chamber 212 may include a gas supplying port 211 and a gas outlet port 219. The first and second ionizing electrodes 214 and 216 may be disposed facing each other in the ionizing chamber 212. An insulation material may be applied between the first and second ionizing electrodes 214 and 216 and the ionizing chamber 212. The first ionizing electrode 214 may be connected to an electric power applier 215. The second ionizing electrode 216 may be connected to an earth line 217.

The gas pressurizing unit 220 can pressurize the ionized gas. For example, the gas pressurizing unit 220 may include a pressurizing chamber 222. The pressurizing chamber 222 may include at least one compressor.

The gas storage unit 230 can store the ionized gas. The gas storage unit 230 may include a storage chamber 232, a gas collecting unit 233, and an electromagnetic field generator.

The storage chamber 232 may have an inner space in which the ionized gas can be stored. For example, the storage chamber 232 may be formed in a hexahedron shape. Alternatively, the storage chamber 232 may be formed in a cylindrical shape. The storage chamber 232 may include a top wall 232a, a bottom wall 232b, and a sidewall 232c connecting the top wall 232a to the bottom wall 232b. The top wall 232a may be provided with a gas inlet port 231a. The bottom wall 232b may be provided with a gas supplying port 231b.

The gas collecting unit 233 can store the ionized gas in the storage chamber 232. The gas collecting unit 233 may be disposed in the storage chamber 232 and fixed in the storage chamber 232 by a gas collecting unit supporting member 234. The gas collecting unit 233 may include a material that can collect the ionized gas. For example, the gas collecting unit 233 may include porous microspheres or nano materials. The gas collecting unit 233 may be formed of a variety of kinds of metal. For example, the gas collecting unit 233 may include carbon, magnesium, steel, titanium, lanthanum, nickel, zirconium, and alloy thereof.

The electromagnetic field generator can convert a moving direction of the ionized gas by generating magnetic field and electric field in the storage chamber 232. The electromagnetic field generator may include at least one of a magnetic field generator 235 and an electric field generator 236. In this exemplary embodiment, description is made on a case where both of the magnetic and electric field generators 235 and 236 are provided.

The magnetic field generator 235 can generate the magnetic field B in the storage chamber 232. The magnetic field generator 235 may include at least one magnet. For example, the magnetic field generator 235 may include first and second magnets 235a and 235b. The first and second magnets 235a and 235b may be formed in a plate shape and respectively disposed on the top and bottom walls 232a and 232b. Therefore, the first and second magnets 235a and 235b may be spaced apart from each other and face each other.

The electric field generator 236 can generate electric field E in the storage chamber 232. The electric field E may be alternating current electric field. The electric field generator 236 may include electrodes. For example, the electric field generator 236 may include first and second electrodes 236a and 236b in the storage chamber 232. The first and second electrodes 236a and 236b may be disposed on the sidewall 232c. For example, the first electrode 236a may be disposed on one side of the sidewall 232c of the storage chamber 232 and the second electrode 236b may be disposed on opposite side of the sidewall 232c of the storage chamber 232. Therefore, the first and second electrodes 236a and 236b may be disposed facing each other.

The gas treating apparatus 200 may further include a reducer and a heating unit 239. The reducer can reduce a moving speed of the ionized gas introduced into the storage chamber 232. For instant, the reducer may include a cooling unit 237 for cooling the gas collecting unit 233. The cooling unit 237 includes at least one of a cooling pin and a cooling plate that is disposed adjacent to the gas collecting unit 233. Further, the heating unit 239 may heat the gas collecting unit 233. The heating unit 239 may include at least one heater disposed adjacent to the gas collecting unit 233.

Meanwhile, the magnetic field B and the electric field E may be formed in the storage chamber 232. For example, the first magnet 235a may be disposed such that an S-pole thereof faces the storage chamber 232 and the second magnet 235b may be disposed such that an N-pole thereof faces the storage chamber 232. Accordingly, a magnetic field B directing from the second magnet 235b toward the first magnet 235b can be generated in the storage chamber 232. In addition, the first electrode 236a may be positive and the second electrode 236b may be negative. Accordingly, an electric field E directing from the first electrode 236a toward the second electrode 236b can be formed in the storage chamber 232.

The following will describe in detail a gas treating process of the gas treating apparatus 200 according to the exemplary embodiment of the present invention. The contents related to the gas treating apparatus 200, which are already described above, will be omitted or briefed. In addition, the gas treating process of this exemplary embodiment may be similar to that of the foregoing exemplary embodiment.

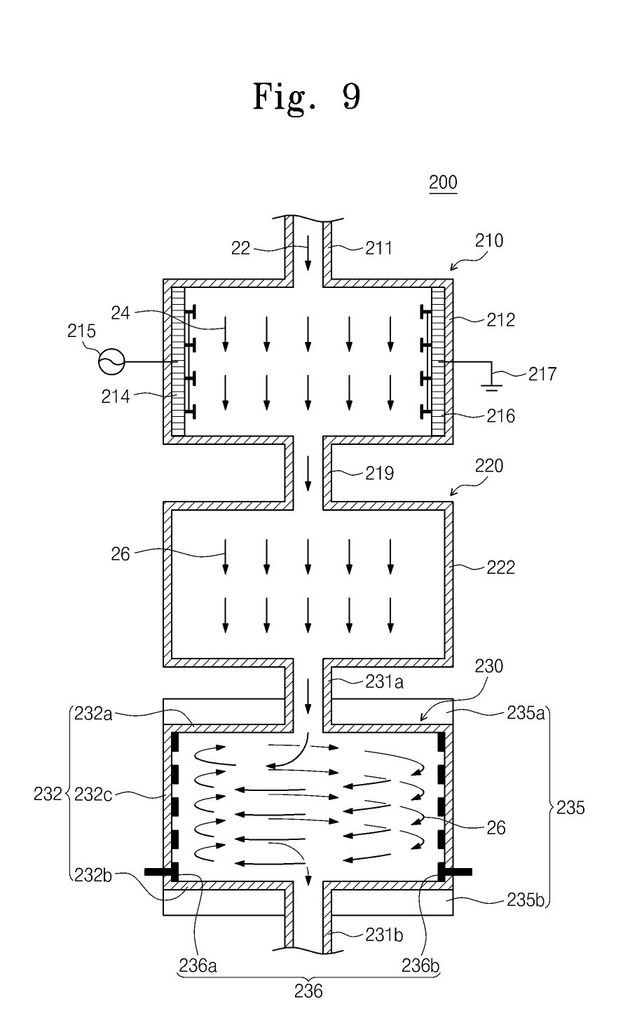

FIG. 9 illustrates a gas flow during a gas treating process of the gas treating apparatus of FIGS. 7 and 8.

Referring to FIGS. 3, 7, and 9, gas may be ionized (S110). For example, the gas 22 may be supplied into the ionizing chamber 212 of the gas ionizing unit 210 through the gas supplying port 211. The gas may include the hydrogen gas. The gas 22 supplied to the ionizing chamber 212 may be ionized by being charged by the ionizing electrodes 214 and 216. At this point, ionized gas 24 (hereinafter, referred to as “ion gas”) may include positively charged hydrogen gas (H+). Alternatively, the ionized gas 24 may include negatively charged hydrogen gas (H−).

The ion gas 24 may be pressurized (S120). For example, the ion gas 24 may be supplied from the ionizing unit 210 to the pressurizing chamber 222 of the gas pressurizing unit 220 through the gas outlet port 219. The pressurizing chamber 222 may supply the ion gas 24 to the gas storage unit 230 after pressurizing the ion gas 24.

The gas storage unit 230 may store a pressurized ion gas 26 in the storage chamber 232 while providing the magnetic field B and the electric field E to the pressurized ion gas 26 (S130). For example, the pressurized ion gas 26 may be directed into the storage chamber 232 through the gas inlet port 231a. The pressurized ion gas 26 may be guided to stay in the storage chamber 232 by converting its moving direction by the magnetic field B and electric field E generated in the storage chamber 232. That is, as previously described with reference to FIG. 8, the electric field E may be formed in a horizontal direction in the storage chamber 232. Furthermore, the magnetic field B may be formed in the storage chamber 232 in a direction intersecting the horizontal direction. Therefore, the pressurized ion gas 26 can circulate in a leftward and rightward direction on the plane perpendicular to the magnetic field B in the storage chamber 232. The pressurized ion gas 26 having the leftward and rightward circulating flow increases in a contact rate with the gas collecting unit 233. Therefore, the gas storage unit 230 can improve a storage rate of the gas collecting unit 233.

Meanwhile, the pressurized ion gas 26 introduced into the storage chamber 232 may decrease in its speed in the storage chamber 232 by the cooling unit 237. For example, the pressurized ion gas 26 have a high temperature introduced into the storage chamber 232 may move fast and have high reactivity. Therefore, the cooling unit 237 may substantially reduce the moving speed of the pressurized ion gas 26 by cooling the gas collecting unit 233 and thus cooling the pressurized ion gas 26. In this case, the gas collecting unit 233 may not be heated by the heating unit 239. Through a series of the above-described processes, the gas collecting unit 233 can collect and store the pressurized ion gas 26.

The gas collected in the gas collecting unit 233 may be used according to the following process. For example, it is first determined if the gas will be used (S140). For instant, the gas supplying port 231b may be connected to a process unit (not shown) using the gas stored in the storage chamber 232. When the process unit intends to use the gas stored in the storage chamber 232, the heating unit 239 may heat the gas collecting unit 233 (S150). At this point, the cooling of the gas collecting unit 233 by the cooling unit 237 may be stopped. When the gas collecting unit 233 is heated by the heating unit 239, the hydrogen gas collected in the gas collecting unit 233 is separated from the gas collecting unit 233 and is supplied to the process unit through the gas supplying port 231b. Further, when the use of the gas by the process unit is stopped, the heating of the gas collecting unit 233 by the heating unit 239 may be stopped. In addition, the gas collecting unit 233 is cooled by the cooling unit 237.

The following will describe a modified example of the previously described gas treating apparatus according to the exemplary embodiment of FIGS. 7 and 8. The contents related to the gas treating apparatus 100, which are already described above, will be omitted or briefed.

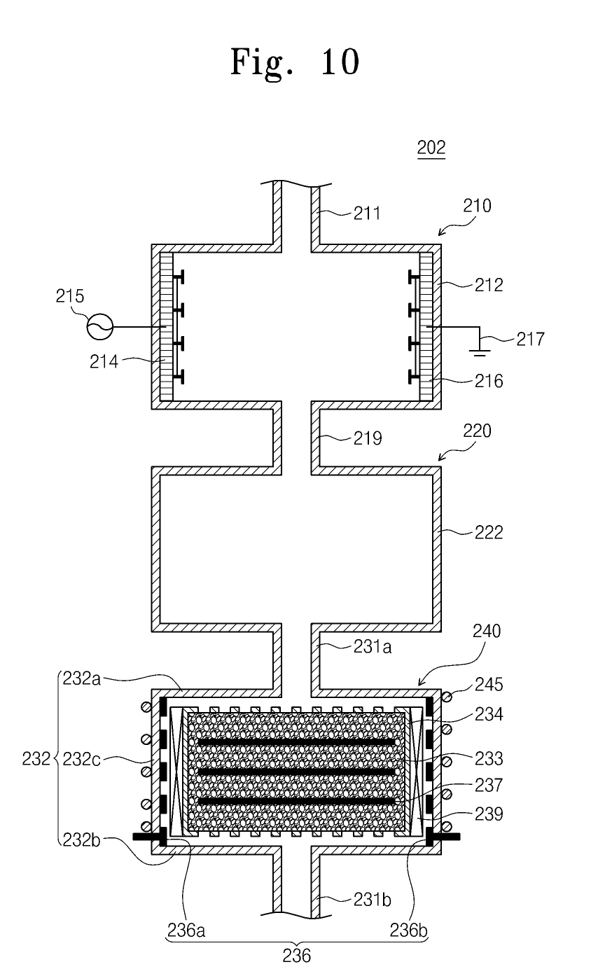

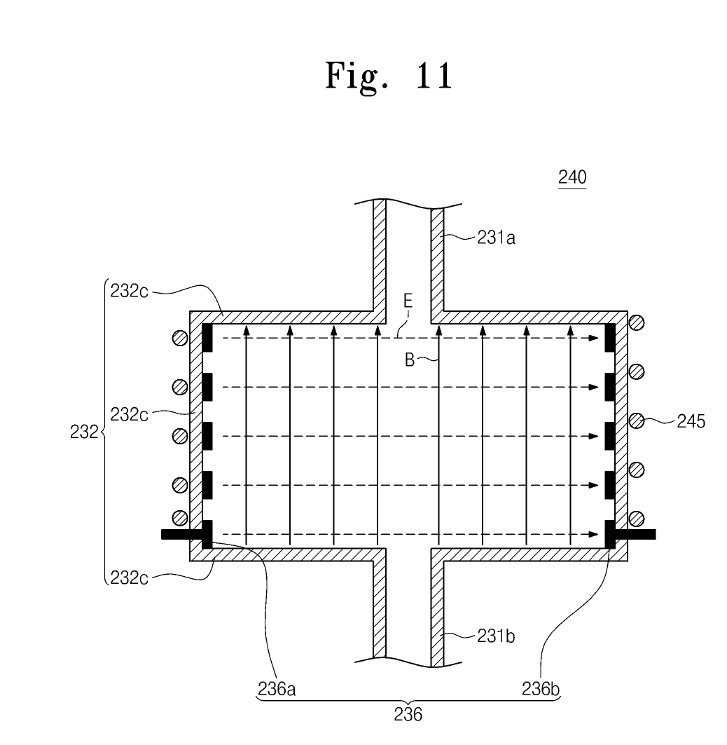

FIG. 10 is a schematic view of a modified example of the gas treating apparatus of the exemplary embodiment of FIGS. 7 and 8, and FIG. 11 is a schematic view of magnetic and electric fields in a gas storage unit of FIG. 11.

Referring to FIGS. 10 and 11, a gas treating apparatus 202 according to this modified example includes a gas ionizing unit 210, a gas pressurizing unit 220, and a gas storage unit 240.

The gas ionizing unit 210 may include an ionizing chamber 212 and first and second ionizing electrodes 214 and 216 that are disposed facing each other in the ionizing chamber 212. The ionizing chamber 212 may include a gas supplying port 211 and a gas outlet port 219. The first electrode 214 may be connected to an electric power applier 215. The second ionizing electrode 216 may be connected to an earth line 217. The gas pressurizing unit 220 may include a pressurizing chamber 222 connected to the gas outlet port 219 and a gas inlet portion 231a.

The gas storage unit 240 may include a storage chamber 232, a gas collecting unit 233, and an electromagnetic field generator. The gas treating apparatus 202 may further include a cooling unit 237 cooling the gas collecting unit 233 and a heating unit heating the gas collecting unit 233.

The storage chamber 232 may have an inner space in which the ionized gas can be stored. The storage chamber 232 may be formed in a hexahedron shape. Alternatively, the storage chamber 232 may be formed in a cylindrical shape. The storage chamber 232 may include a top wall 232a, a bottom wall 232b, and a sidewall 232c connecting the top wall 232a to the bottom wall 232b. When the storage chamber 232 is formed in the cylindrical shape, the top wall 232a, bottom wall 232b, and sidewall 232c are rounded to define the cylindrical shape. The top wall 232a may be provided with the gas inlet port 231a. The bottom wall 232b may be provided with a gas supplying port 231b. The gas collecting unit 233 can store the ionized gas. The gas collecting unit 233 may be physically fixed in the storage chamber 232 by a gas collecting unit supporting member 234.

The electromagnetic field generator may include a magnetic field generator 245 and an electric field generator 236. In this case, the magnetic field generator 245 may be formed with coils. In this case, the magnetic field generator 245 may be formed enclosing an outer wall of the storage chamber 232. For example, the magnetic field generator 245 may be disposed enclosing the sidewall 232c of the storage chamber 232. The electric field generator 236 can generate electric field E in the storage chamber 232. The electric field E may be alternating current electric field. The electric field generator 136 may include first and second electrodes 236a and 236b disposed on the sidewall 232c. At this point, the first and second electrodes 236a and 236b may be disposed facing each other in the storage chamber 232.

Meanwhile, since the magnetic field generator 245 is formed with coils enclosing the storage chamber 232, the magnetic field B may be generated in a horizontal direction by the magnetic field generator 245. Further, the first electrode 236a may be positive and the second electrode 236b may be negative. Accordingly, an electric field E is generated in the storage chamber 232 in a direction (i.e., a vertical direction) intersecting the horizontal direction.

This modified example differs from the gas treating apparatus 200 of FIGS. 7 and 8 in that the gas treating apparatus 202 has the magnetic field generator 245 formed with the coils to generate the magnetic field B in the storage chamber 232. Therefore, the magnetic field B can be formed in the storage chamber 232. At this point, the directions of the magnetic and electric field E may be similar to the exemplary embodiment of FIG. 8.

According to the exemplary embodiments of the present invention, the gas supplying efficiency can be improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

For example, in the foregoing exemplary embodiments, it is described that the magnetic field generated by the magnetic field generator has a different direction from the electric field generated by the electric field generator. However, the magnetic field generated by the magnetic field generator may have a same different direction as the electric field generated by the electric field generator. To realize this, other modified examples where polarities of the magnets are varied or the kind of the electric power applied to the electrodes are varied. In addition, in the foregoing embodiments, it is described that both of the magnetic and electric field generators are provided. However, modified examples where only one of the magnetic and electric field generators may be provided, two or more magnetic field generators may be provided, or two or more electric field generators may be provided may be possible. In the foregoing embodiments, a technique for treating hydrogen gas is described. However, the present invention may be applied for the treatment of a variety of other gases. It should be understood that these modified examples are included in the scope of the present invention as the modified examples can be easily embodied by the persons skilled in the art.

What is claimed is:

1. A gas treating apparatus comprising:
a storage chamber having a top wall, a bottom wall facing the top wall, and a sidewall connecting the top wall to the bottom wall;
a gas collecting unit provided in the storage chamber and storing ionized gas; and
an electromagnetic field generator converting a moving direction of the ionized gas,
wherein the electromagnetic generator comprises at least one of a magnetic field generator generating a magnetic field in the storage chamber and an electric field generator generating an electric field in the storage chamber.

2. The gas treating apparatus of claim 1, wherein the magnetic field generator comprises a plate-shaped magnet on the sidewall; and
the electric field generator comprises electrodes on the top and bottom walls.

3. The gas treating apparatus of claim 1, wherein the magnetic field generator comprises a coil enclosing the top wall, bottom wall, and sidewall; and
the electric field generator comprises electrodes on the top and bottom walls.

4. The gas treating apparatus of claim 1, wherein the magnetic field generator comprises plate-shaped magnets on the top and bottom walls; and
the electric field generator comprises electrodes on the sidewall.

5. The gas treating apparatus of claim 1, wherein the magnetic field generator comprises a coil enclosing the sidewall; and
the electric field generator comprises electrodes on the sidewall.

6. The gas treating apparatus of claim 1, further comprising an ionizing unit ionizing the gas.

7. The gas treating apparatus of claim 6, further comprising a gas pressurizing unit pressurizing the ionized gas.

8. The gas treating apparatus of claim 1, further comprising a reducer reducing a moving speed of the ionized gas in the storage chamber and the reducer comprises a cooling unit cooling the gas collecting unit.

9. The gas treating apparatus of claim 8, wherein the gas storage unit comprises a heating unit heating the gas collecting unit.

10. A gas treating method using a storage chamber and a gas collecting unit dispose in the storage chamber, the method comprising:
storing ionized gas in the gas collecting unit by generating at least one of magnetic field and electric field.

11. The gas treating method of claim 10, wherein the magnetic field and electric field allow the ionized gas to stay in the storage chamber.

12. The gas treating method according to claim 10, wherein the electric field is provided in an inflow direction of the ionized gas introduced into the storage chamber; and
the magnetic field is provided in a direction intersecting the inflow direction.

13. The gas treating method of claim 10, wherein the electric field is provided in a direction intersecting an inflow direction of the ionized gas introduced into the storage chamber; and
the magnetic field is provided in the inflow direction.

14. The gas treating method of claim 10, further comprising ionizing gas before the gas is stored in the gas collecting unit.

15. The gas treating method of claim 10, further comprising using the ionized gas stored in the storing chamber, wherein using the ionized gas comprises heating the gas collecting unit.
